(19) United States
(12) Patent Application Publication
(10) Pub. No.: US 2026/0249339 A1
(43) Pub. Date: Aug. 27, 2026

(54) ROBUST DETERMINATION OF EDGE WAVES OF A METAL STRIP

(71) Applicant: Primetals Technologies Germany GmbH, Erlangen (DE)

(72) Inventors: Martin KERSCHENSTEINER, Berg (DE); Klaus LOEHE, Fürth (DE); Dominik WASSERMANN, Augsburg (DE)

(21) Appl. No.: 19/545,614

(22) Filed: Feb. 20, 2026

(30) Foreign Application Priority Data
Feb. 25, 2025 (EP) 25159954.4

(51) Int. Cl. B21B 38/00; G06T 7/00; G06T 7/13

(52) U.S. Cl. CPC B21B 38/00; G06T 7/001; G06T 7/13; G06T 2207/10016; G06T 2207/30136

(57) ABSTRACT

A metal strip (2) that extends in a width direction (yB) over a strip width (b) from an operator-side to a drive-side strip edge (4, 5) runs out of a roll stand (1) in a direction of transport (xB). An evaluation means (13) iteratively and repeatedly receives from a camera (8) an image (B) of the metal strip (2) captured by the camera (8). The camera (8) is arranged laterally above the metal strip (2). The evaluation means (13) determines, in a two-dimensional coordinate system relating to the respective image (B), for the operator-side and the drive-side strip edge (4, 5), the value of the one coordinate (y) as a function of the other coordinate (x) and thereby determines in the respective image (B) a characteristic of the respective strip edge (4, 5) as a function of the other coordinate (x). The evaluation means (13) uses the functional characteristic of the respective strip edge (4, 5) within a respective evaluation range (16) of the images (B) to determine a measure (M1, M2) for the edge waviness of the respective strip edge (4, 5).

### FIELD

The present invention is based on a method of determination for an edge waviness of a metal strip that extends in a width direction over a strip width from an operator-side to a drive-side strip edge and runs out of a roll stand in a direction of transport,
wherein an evaluation means iteratively and repeatedly receives from a camera an image of the metal strip captured by the camera.

The present invention is additionally based on a computer program for a software-programmable evaluation means, wherein the computer program comprises machine code that can be directly processed by the evaluation means, wherein the processing of the machine code by the evaluation means causes the evaluation means to execute such a method of determination.

The present invention is additionally based on an evaluation means, wherein the evaluation means is software-programmable and is programmed by use of such a computer program, such that the evaluation means executes such a method of determination.

The present invention is additionally based on a rolling means,
wherein the rolling means has a roll stand for rolling a metal strip extending in a width direction over a strip width from an operator-side to a drive-side strip edge, such that the metal strip runs out of the roll stand in a direction of transport,
wherein the rolling means has a camera,
wherein the rolling means has an evaluation means that is connected to the camera via a data link for the purpose of receiving images captured by means of the camera, is realized as such an evaluation means and executes such a method of determination.

### PRIOR ART

The subject-matters mentioned are known, for example, from WO 2023/041 253 A1.

In the case of the aforementioned WO document, the camera is arranged centrally above the metal strip. The position of the strip edges is detected in order to determine the range within which the metal strip is to be further evaluated for waviness. This involves evaluating intensity fluctuations of bands running in the direction of transport of the metal strip. The individual bands are each only of a small width. As a whole, however, they cover the entire width of the metal strip. The evaluation of the two bands at the edges of the metal strip therefore provides a measure for edge waves that occur.

The capturing of images of a metal strip running out of a roll stand and the determination of flatness values based on this are also known from WO 2021/105 364 A2, JP H04 279 208 A and EP 2 258 492 A1

### SUMMARY OF THE INVENTION

In the rolling of a metal strip, the constant endeavor is to produce a flat metal strip that is both stress-free in itself and free of outward distortion and therefore flat. This is the case if a metal strip is rolled completely evenly in the width direction, i.e. with a uniform relative draft as viewed in the width direction. If rolling is uneven in the width direction, some longitudinal bands of the metal strip (as viewed in the width direction) are rolled more than other longitudinal bands of the metal strip. The metal strip therefore forms waves in the more heavily rolled longitudinal bands. This can result in center waves, edge waves and so-called quarter waves. The metal strip therefore becomes non-planar, the outer (=visible) flatness being other than 0. If there are small differences in length or if the metal strip is subjected to tension, the external flatness is 0, but if tension is applied, the differences in length result in internal tensile stress differences. In this case, the internal stress of the metal strip is therefore other than 0. The waves mentioned can still be present in the case of major non-planarity even if the metal strip is subjected to tension. The recognition and, if possible, correction of planarity defects in the rolled metal strip is of great importance.

The environmental conditions in the rolling of a metal strip are often challenging, for example due to high temperatures, vibration, water, or water vapor, oil vapors, as well as dirt and rust particles. This complicates the operation of measuring devices for acquiring values that are characteristic of planarity defects, and often results in high costs and a high space requirement.

The object of the present invention is to create possibilities by means of which at least edge waves can be easily recognized in the rolled metal strip.

The object is achieved by a method of determination having the claimed features. Advantageous designs of the operating method are the subject-matter of the dependent claims.

According to the invention, a method of determination of the type mentioned at the outset is designed in that
the camera is arranged laterally above the metal strip,
the evaluation means determines, in a two-dimensional coordinate system relating to the respective image, for the operator-side and the drive-side strip edge, the value of the one coordinate as a function of the other coordinate and thereby determines in the respective image a characteristic of the respective strip edge as a function of t coordinate, and
the evaluation means uses the functional characteristic of the respective strip edge within a respective evaluation range of the images to determine a measure for the edge waviness of the respective strip edge.

The wording that the camera is “arranged laterally above the metal strip” restricts the arrangement of the camera in two respects. Firstly, the camera must be arranged in such a way that, as viewed vertically, it is arranged above the metal strip, such that the captured images show the top side of the metal strip. Secondly, the camera must be arranged in such a way that, as viewed in the width direction, the operator-side strip edge is arranged between the camera and the drive-side strip edge. The camera is thus not arranged over the metal strip. If the camera were arranged over the metal strip, but not laterally above it, it would be arranged, as viewed in the width direction, between the two strip edges.

The arrangement of the camera affects the circumstances that can be captured by the camera and that can be recognized the captured images. In particular, in the images captured in the manner according to the invention, the value of the one coordinate is dependent, for a particular value of the other coordinate, on the height of the corresponding strip edge. If, on the other hand, the camera were arranged over the metal strip, the value of the one coordinate would not depend, or at least would depend only insignificantly, on the height of the corresponding strip edge at this location.

The operator-side strip edge determined in the images is the lower strip edge on this side of the metal strip. Although the upper operator-side strip edge is depicted in the images, it is generally not recognizable. The drive-side strip edge determined in the images is the upper strip edge on this side. The lower drive-side strip edge is concealed in the images by the metal strip as such.

The captured images are two-dimensional. They may be “normal” optical images, i.e. captured in the visible spectrum, or infrared images. Infrared images are particularly suitable when the metal strip is hot-rolled in the roll stand. However, the method of determination according to the invention is applicable not only to hot rolling of a metal strip, but also to cold rolling of a metal strip.

The method of determination according to the invention can be used in a variety of ways. For example, it may be integrated—in a manner similar to WO 2023/041 253 A1—into a planarity control system. In this case, the method of determination must be executed in real time. The evaluation means in this case is either itself the control means for the roll stand or it is connected via a data link to such a control means. Alternatively or additionally, the method of determination according to the invention may be integrated into an adaptation of a model by means of which a set-up calculation for the rolling of a subsequent metal strip is effected. In this case, real-time execution is not required. Again alternatively or additionally, the evaluation means may communicate with an operator. For example, the evaluation means may output to the operator, in particular in a visualized form, the measures determined for the edge waviness of the strip edges. The evaluation means may also output a visual, acoustic and/or other type of alarm to the operator, for example when a threshold value is exceeded.

Preferably, the direction of the other coordinate of the coordinate systems runs substantially in the direction of transport. This design facilitates the evaluation of the images. The term “substantially” is intended to mean a maximum deviation of 5° in the direction of the other coordinate from the direction of transport.

As a rule, the image elements of the respective image form an orthogonal, uniform grid that has two mutually orthogonal preferential directions. Preferably, the other coordinate of the coordinate systems coincides substantially with one of these two preferential directions. This design, likewise, facilitates the evaluation of the images. As before, the term “substantially” is intended to mean a maximum deviation of 5° of the other coordinate from the preferential direction.

In the simplest case, the evaluation range of the evaluation means is predefined in a fixed manner. Alternatively, it is possible for the evaluation means to receive the evaluation range from an operator. This design is both simple and nevertheless very flexible. In yet another design, the evaluation means automatically determines the evaluation range based on the received images. In this case, on the one hand, the evaluation range can be optimized in a flexible manner and, on the other hand, the operator is relieved of the task of making an exact determination. Regardless of which procedure is used, appropriate specification of the evaluation range allows disruptive effects that can occur in the front and the rear region of the metal strip to be suppressed.

If the evaluation range is determined automatically, it is preferably provided that for this purpose the evaluation means
defines a provisional lower and/or a provisional upper limit for the other coordinate and for a plurality of images determines for the respective strip edge, between the provisional lower and the provisional upper limit, the scatter or the variance of the respective functional characteristic in the direction of the one coordinate,
varies the provisional lower and/or provisional upper limit and for the plurality of images again determines, within the varied provisional lower and the varied provisional upper limit, the scatter or the variance of the respective functional characteristic in the direction of the one coordinate, and
on the basis of the change in the scatter or the variance of the respective functional characteristic in the direction of the one coordinate, determines whether and, if so, in which direction it again varies the provisional lower and/or provisional upper limit or adopts it definitively as the upper and/or lower limit.

In a simple design, the evaluation means determines for the images individually the measure for the edge waviness of the respective strip edge. The measure for the edge waviness of the respective strip edge is therefore determined for each individual image independently of the other images. This type of evaluation is particularly useful for the head of the strip and possibly also for the foot of the strip, i.e. if the metal strip is not subjected to tension.

In the case of evaluation of individual images, it is possible, for example, for the evaluation means, for the purpose of determining the measure of the edge waviness of the respective strip edge, to determine the location spectrum of the functional characteristic of the respective strip edge in the respective image and to evaluate the determined location spectrum. For example, the evaluation means may determine the greatest amplitude and its location frequency, or determine the amplitudes that lie above a threshold value, and the associated location frequencies. Determining of the location spectrum may be effected, for example, by use of a local Fourier transformation, in particular an FFT (=fast Fourier transformation).

As an alternative to evaluating image by image, it is possible for the evaluation means, for the purpose of determining the measure for the edge waviness of the respective strip edge, to utilize a sequence of captured images of the metal strip. This type of evaluation is particularly advantageous if the metal strip is subjected to tension. In this case also—depending on the extent of the tension—edge waves can appear. Generally, the images of the evaluated sequence follow each other immediately. Thus, no recorded images are skipped. However, this is possible in individual cases.

For the purpose of evaluating an entire sequence of images, it is advantageous if the characteristics of the strip edges are directly comparable from image to image. It is therefore preferably provided that the evaluation means, in the images of the sequence for the purpose of evaluating the functional characteristic of the respective strip edge determines for the respective image, in the evaluation range of the respective image, the mean value of the respective functional characteristic in the direction of the one coordinate, and subtracts the determined mean value from the functional characteristic of the respective strip edge determined in the respective image, and thus determines a modified functional characteristic of the respective strip edge in the respective image and, based on the modified characteristics, performs further evaluations for the sequence of images.

In many cases, good results are obtained if the further evaluations include a statistical evaluation of the modified characteristics of the respective strip edge in the images of the sequence. This is particularly the case if the statistical evaluation includes a determination, with location resolution in the other coordinate, of statistical variables of the respective modified functional characteristic in the direction of the one coordinate.

For example, the mean value, the scatter, the variance and similar variables of the modified characteristics of the respective strip edge may be determined for a particular value of the other coordinate over the images of the sequence. For example, the evaluation means may determine the measure for the edge waviness of the respective strip edge from the scatter or the variance for a particular value of the other coordinate, or from the functional characteristic of the scatter or the variance as a function of the other coordinate. Alternatively or additionally, the evaluation means may determine the measure for the edge waviness of the respective strip edge from the functional characteristic of the mean value as a function of the other coordinate. The latter evaluation may be performed in the same way as explained above for a single image.

As an alternative to a statistical evaluation, it is possible for the evaluation means to determine the measure for the edge waviness of the respective strip edge by evaluating, with location resolution in the other coordinate, over the sequence of images for the modified functional characteristics of the trip edges, the change over time in the direction of the one coordinate.

For this purpose it is possible, in particular, for the evaluation means to determine a time spectrum of the change over time in the direction of the one coordinate and to evaluate the time spectrum. For example, the control means may determine the greatest amplitude and its frequency, or determine the amplitudes that lie above a threshold value, and the associated frequencies. The time spectrum may be determined, for example, by use of a time Fourier transformation, in particular an FFT (=fast Fourier transformation).

Preferably, the evaluation means accepts changes in the measure for the waviness of the respective strip edge as valid only if these changes persist for a period of time that is greater than a minimum period of time. Short-term fluctuations and interference can thus be easily filtered out.

Preferably, the evaluation means determines a movement of the camera during the capturing of the images and corrects the position of the respective coordinate system in the captured images by the movement of the camera before determining the functional characteristic of the respective strip edge. A major source of error can thus be eliminated.

For the purpose of determining the movement of the camera, the camera may comprise, for example, acceleration and/or rotation sensors. In this case, the evaluation means may receive the corresponding sensor signals and use them to determine the movement of the camera. It is also possible for the evaluation means to know the locations of fixed structures that must be present in the captured images. In this case, the evaluation means may determine at which points in the captured images the fixed structures are located, and from this determine the movement of the camera. The fixed structures may be, for example, a stand support of the roll stand or a downstream roll stand or elements arranged on a stand support. A sling lifter might also be regarded as a “fixed structure” if its respectively current position is known by the evaluation means.

The object is additionally achieved by a computer program having the claimed features. According to the invention, the processing of the machine code by the evaluation means causes the evaluation means to execute a method of determination according to the invention.

The object is furthermore achieved by an evaluation means having the claimed features. According to the invention, the evaluation means is software-programmable and programmed with a computer program according to the invention, such that the evaluation means executes a method of determination according to the invention.

The object is furthermore achieved by a rolling means having the claimed features. According to the invention, in the case of a rolling means of the type mentioned at the outset, the camera is arranged laterally above a pass line on which the metal strip runs out of the roll stand, and the evaluation means is realized as an evaluation means according to the invention, which executes a method of determination according to the invention.

In many cases, the rolling means has a further roll stand, which is arranged on the outlet side of the first-mentioned roll stand. In this case, the camera is preferably arranged between the first-mentioned roll stand and the further roll stand, as viewed in the direction of transport of the metal strip. The camera therefore preferably “views” the metal strip substantially transversely. This results, on the one hand, in particularly high-quality capturing of the strip edges and, on the other hand, in ease of evaluation.

Furthermore, the camera is preferably arranged in such a manner that that an operator-side connection line from the camera to the operator-side strip edge forms, together with an operator-side vertical plane that includes the operator-side strip edge, an operator-side angle that is between 30° and 70°, and/or a drive-side connection line from the camera to the drive-side strip edge forms, together with a drive-side vertical plane that includes the drive-side strip edge, a drive-side angle that is between 30° and 70°. At angles below 30°, the edge waves are only insufficiently visible in the captured images. At angles above 70°, it gradually becomes more and more difficult to distinguish between the two strip edges.

### BRIEF DESCRIPTION OF THE DRAWINGS

The features, characteristics and advantages of the present invention described above and the manner in which they are achieved become clearer and more comprehensible in the context of the following description of an exemplary embodiment, which is explained in greater detail in conjunction with the drawings, in which:

FIG. 1 shows a rolling means from the side,

FIG. 2 shows the rolling means from FIG. 1 from above,

FIG. 3 shows the rolling means from FIG. 1 as viewed counter to a direction of transport of a metal strip,

FIG. 4 shows a sequence diagram,

FIG. 5 shows a sequence diagram,

FIG. 6 shows an image and content of the image,

FIG. 7 a sequence diagram,

FIG. 8 shows a location spectrum,

FIG. 9 shows a sequence diagram,

FIG. 10 shows a frequency distribution,

FIG. 11 shows modified values in the direction of one coordinate in the case of a uniform value of another coordinate,

FIG. 12 shows a determination and an evaluation of a time spectrum,

FIG. 13 shows a sequence diagram,

FIG. 14 shows a sequence diagram,

FIG. 15 shows a sequence diagram, and

FIG. 16 shows an image and content of the image.

### DESCRIPTION OF THE EMBODIMENTS

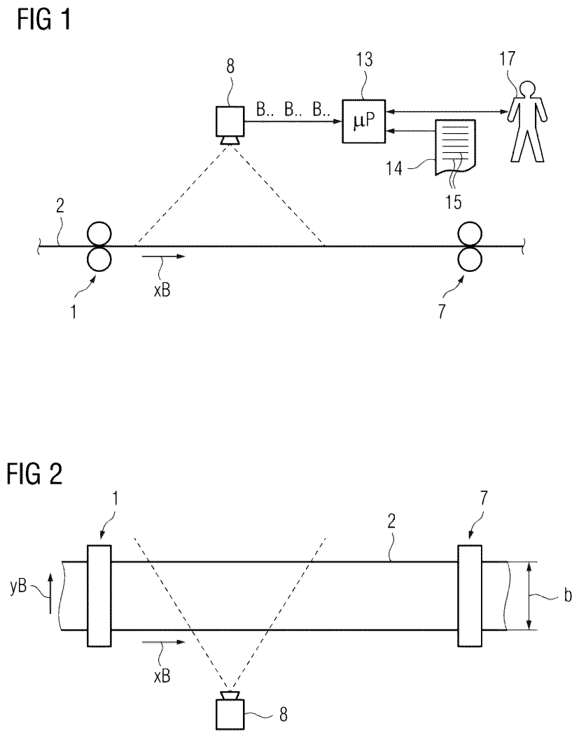

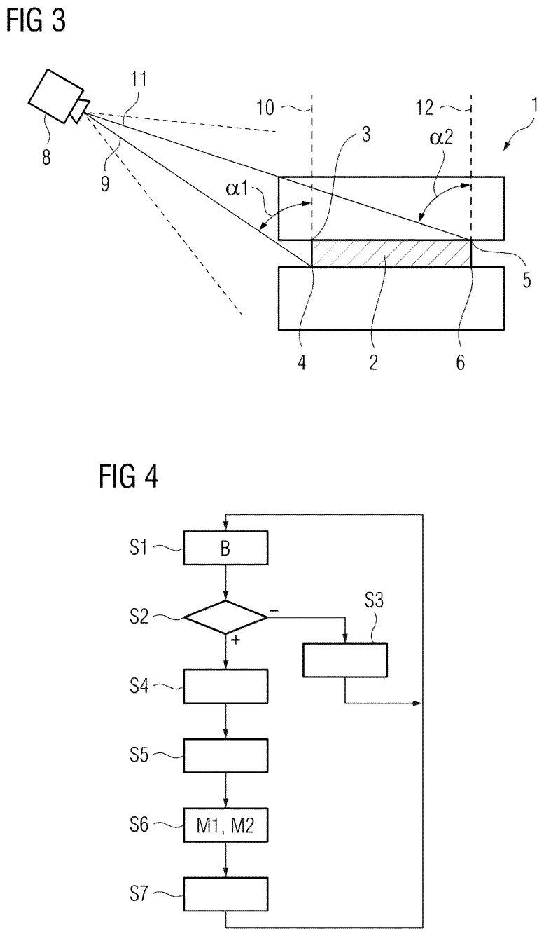

As shown in FIGS. 1 to 3, a metal strip 2 is rolled in a roll stand 1. Only the working rollers of the roll stand 1 are represented in FIGS. 1 to 3. As a rule, however, the roll stand 1 has further rollers in addition to the working rollers, in particular support rollers. The metal strip 2 extends in a width direction yB over a strip width b. On one side, there is an upper operator-side strip edge 3 and a lower operator-side strip edge 4. On the other side, there is an upper drive-side strip edge 5 and a lower drive-side strip edge 6. The metal strip 2 runs out of the roll stand 1 in a direction of transport xB. In many cases, there is also another roll stand 7 in addition to the roll stand 1. The additional roll stand 7, if present, is arranged on the output side of the roll stand 1. Of the roll stand 7, also, only the working rollers are represented in FIGS. 1 and 2. As a rule, the further roll stand 7 also has further rollers in addition to the working rollers, in particular support rollers.

There is also a camera 8. As shown in FIGS. 1 to 3, the camera 8 is arranged laterally above a pass line on which the metal strip 2 runs out of the roll stand 1. The camera 8 therefore “looks” laterally from above onto the metal strip 2. The dashed lines extending from the camera 8 are intended to indicate the capture range of the camera 8. The capture range is selected so that both the two operator-side strip edges 3, 4 and the upper drive-side strip edge 5 lie within the capture range.

An operator-side connection line 9 from the camera 8 to the (lower) operator-side strip edge 4 forms, together with an operator-side vertical plane 10, an operator-side angle α1. The operator-side vertical plane 10 is defined in that it includes the (lower) operator-side strip edge 4 and is vertical. Preferably, the camera 8 is arranged in such a way that the operator-side angle α1 is between 30° and 70°. Strictly speaking, the operator-side angle α1 varies over the capture range over which the operator-side strip edge 4 is captured. The maximum value, the minimum value or the arithmetic mean value of the operator-side angle α1 may be used as the operator-side angle α1 as required.

Similarly, a drive-side connection 11 from the camera 8 to the (upper) drive-side strip edge 5 forms, together with a drive-side vertical plane 12, a drive-side angle α2. The drive-side vertical plane 12 is defined in it includes the (upper) drive-side strip edge 5 and is vertical. Preferably, the camera 8 is arranged in such a way that the drive-side angle α2 is between 30° and 70°. Similarly to the operator-side angle α1, the operator-side angle α2 also varies over the capture range over which the drive-side strip edge 5 is captured. The maximum value, the minimum value or the arithmetic mean value of the drive-side angle 2 may be used as the drive-side angle α2 as required. In any case, however, the drive-side angle α2 is greater than the operator-side angle α1.

If the further roll stand 7 is present, the camera 8 is also generally arranged between the roll stand 1 and the additional roll stand 7, as viewed in the direction of transport xB of the metal strip 2.

As shown in FIG. 1, the camera 8 is connected to an evaluation means 13 via a data link. The camera 8 is thereby able to transmit the images B it has captured to the evaluation means 13. The evaluation means 13 receives the captured images B and evaluates them. As indicated by the designation “μP”, the evaluation means 13 is software programmable. The evaluation means 13 is programmed with a computer program 14, which in turn comprises machine code 15. The machine code 15 can be processed directly by the evaluation means 13. The processing of the machine code 15 by the evaluation means 13 causes the evaluation means 13 to execute a method of determination, which is explained in greater detail below, initially in conjunction with FIG. 4, and later also in conjunction with the other FIGs.

As shown in FIG. 4, in a step S1 the evaluation means 13 receives from the camera 8 an image B of the metal strip 2 captured by the camera 8.

In a step S2, the evaluation means 13 checks whether a sequence of already received images B stored in the evaluation means 13 is already complete.

For as long as the sequence is still incomplete, the evaluation means 13 proceeds to a step S3. In step S3, the evaluation means 13 adds the image B, received in step S1, to the sequence. The evaluation means 13 then returns to step S1.

As soon as the sequence is complete, the evaluation means 13 proceeds to step S4. In step S4, the evaluation means 13 removes the oldest image B from the sequence. Then, in a step S5, the evaluation means 13 adds the image B received in step S1 to the sequence. The sequence is now complete again, but has been updated by one cycle.

In a subsequent step S6, the evaluation means 13 evaluates the images B of the sequence of images B. In step S6, it determines a measure M1 for the edge waviness of the lower operator-side strip edge 4, and a measure M2 for the edge waviness of the upper drive-side strip edge 5. The step S6 is the actual core subject-matter of the present invention. It will be explained in detail later.

In a subsequent step S7, the evaluation means 13 performs further actions, for example visualization of the results of step S6, or sending a message to a control means that controls the roll stand 1. The control means is not represented in the FIG. From step S7, the evaluation means 13 returns to step S1.

The evaluation means 13 thus iteratively and repeatedly executes the sequence of steps S1 to S7, and thus in particular the receiving of a respective image B and the evaluation of the images B of the respective sequence. A cycle time may correspond to a frequency in the range of a standard video frequency, thus for example between 20 and 80 images B per second, in particular between 30 and 60 images B per second. For example, in the case of capture of 25 images per second, the cycle time is 40 ms.

Within step S6, as shown in FIG. 5 the evaluation means 13, in a step S11, first picks out one of the images B from the sequence of images B.

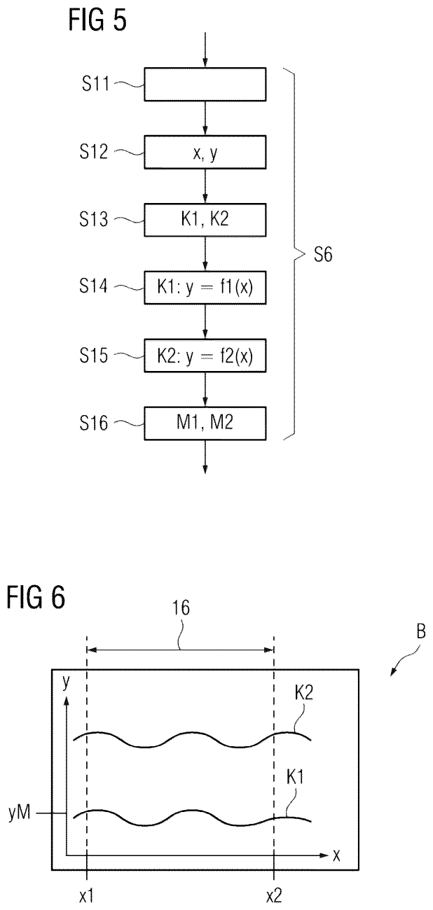

For the image B selected in step S11, in step S12 the evaluation means 13 determines coordinates x, y of a coordinate system. The evaluation means 13 thus defines the coordinate system for the selected image B. The coordinate system is two-dimensional and, as shown in FIG. 6, relate to the respective image B. In the simplest case, the coordinate x runs in the longitudinal direction of the image B and the coordinate y runs in the vertical direction of the image B.

FIG. 6 also at the same time shows two preferred designs. One preferred design is that the direction of the x-coordinate (“other coordinate” within the meaning of the claims) runs substantially in the direction of transport xB of the metal strip 1. Secondly, the individual image elements (pixels) of the respective image B generally form an orthogonal, uniform raster. The raster thus has two mutually orthogonal preferential directions. The other preferred design is that the x direction coincides with one of these two preferential directions and, as a result, the y direction coincides with the other of these two preferential directions.

For the image B selected in step S11, in a step S13 the evaluation means 13 determines the representations K1, K2 of the strip edges 4, 5. For example, if the metal strip 2 is being hot-rolled in the roll stand 1 and the camera 8 is a thermal imaging, or infrared, camera, the evaluation means 13 can determine the sharp transitions from low to high intensity values in the image B and determine the respective transition as a representation K1, K2 of the strip edges. 5. Corresponding methods of determination for edge detection are generally known to persons skilled in the art. FIG. 6, purely by way of example, shows the representations K1, K2 determined. Of course, the representations K1, K2 could also have a different characteristic of the strip edges 4, 5.

In a step S14, the evaluation means 13 determines, for the operator-side strip edge 4, or its representation K1, the value of the one coordinate y as a function of the other coordinate x. In step S14, the evaluation means 13 thus determines, in the image B and the coordinate system, relating to the image B, for the operator-side strip edge 4, or its representation K1, a characteristic of the respective strip edge 4, or its representation K1, as a function of the coordinate x:

$$K 1 : y = f 1 ( x ) .$$

In a step S15, the evaluation means 13 performs the same procedure for the drive-side strip edge 5, or its representation K2:

$$K 2 : y = f 2 ( x ) .$$

Then, in a step S16, the evaluation means 13 uses the functional characteristic of the respective strip edge 4, 5, or of the corresponding representation K1, K2, to determine the measures M1, M2 for the edge waviness of the respective strip edge 4, 5. The evaluation means 13 evaluates the respective functional characteristic only within a respective evaluation range 16 of the images B in this case. To determine the measure M1, the evaluation means 13 utilizes the functional characteristic for the representation K1, and to determine the measure M2, it utilizes the functional characteristic for the representation K2.

In the following, only the operator-side strip edge 4 and the associated functional characteristic for the representation K1, and the measure M1 determined as a result, are considered for the entire description. For the drive-side strip edge 5, the associated functional characteristic for the representation K2, and the M2 determined as a result, entirely similar explanations apply in each case.

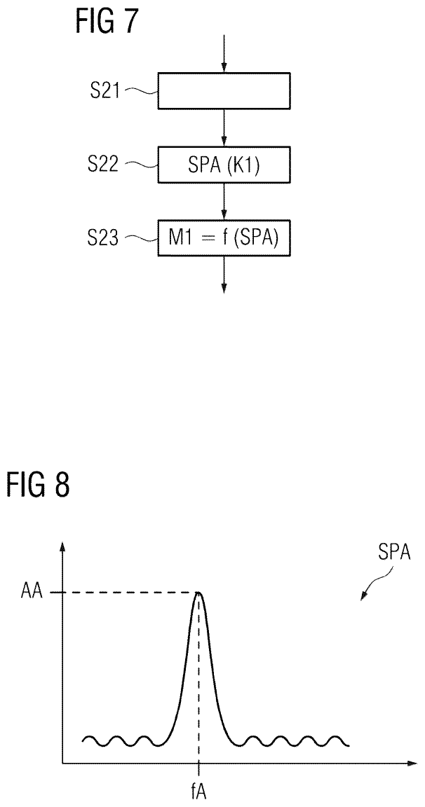

In some cases, the evaluation means 13 determines the measure M1 for the edge waviness of the operator-side strip edge 4 individually, i.e. image B by image B. For example, in a step S21 as shown in FIG. 7, the evaluation means 13 may select one of the images B. In a step S22, the evaluation means 13 then determines the location spectrum SPA of the functional characteristic of the operator-side strip edge 4, or of its representation K1. FIG. 8 shows an example of a possible location spectrum SPA. To determine the dimension M1, in a step S23 the evaluation means 13 evaluates the spatial spectrum SPA. For example, as represented in FIG. 8, the evaluation means 13 may determine the greatest amplitude AA and the associated location frequency fA in the spatial spectrum SPA and use these two values to determine the measure M1. The measure M1 depends at least on the greatest amplitude AA and, the greater the greatest amplitude AA, the greater is that measure. The dependence on the associated location frequency fA is usually less. Other types of evaluation are also possible.

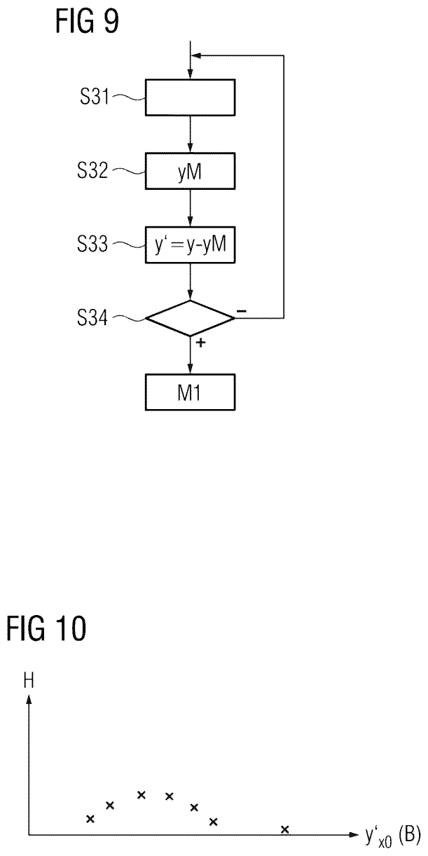

As a rule, however, the evaluation means 13 utilizes a sequence of captured images B of the metal strip 2 to determine the measure M1 for the edge waviness of the strip edge 4. If a sequence of captured images B is utilized, the contents of the images B must be comparable with each other. To enable the images B, or the functional characteristics of the operator-side strip edge 4, or of the respective representation K1, contained in the images B, or to enable these to be viewed across images, modified characteristics are determined in a preparatory procedure. This procedure is explained below in conjunction with FIG. 9.

As shown in FIG. 9, in a step S31 the evaluation means 13 selects one of the images B of the sequence. In a step S32, the evaluation means 13 determines, in the evaluation range 16 of this image B, the mean value yM of the functional characteristic of the operator-side strip edge 4, or of the respective representation K1. It thus takes the y values that occur for the various x values, adds them together and divides the sum by the number of X values. The mean value yM for the representation K1 is also plotted in FIG. 6. In a step S33, the evaluation means 13 subtracts the mean value yM determined in step S32 from the y values and thus determines a modified functional characteristic of the operator-side strip edge 4 in the respective image B. The y values of the modified functional characteristic are denoted below by the reference designation y′.

In a step S34, the evaluation means 13 checks whether it has already executed the steps S31 to S33 for all images B of the sequence. For as long as this is not the case, the evaluation means 13 returns to step S31. In the re-execution of the step S31, the evaluation means 13 selects one of the images B of the sequence for which it has not yet executed steps S32 and S33. Otherwise, the preparation is complete. In a step S35, the evaluation means 13 may thus, based on the modified characteristics, perform further evaluations for the sequence of images B, in particular determine the measure M1.

Various possible designs of the step S35 are explained below.

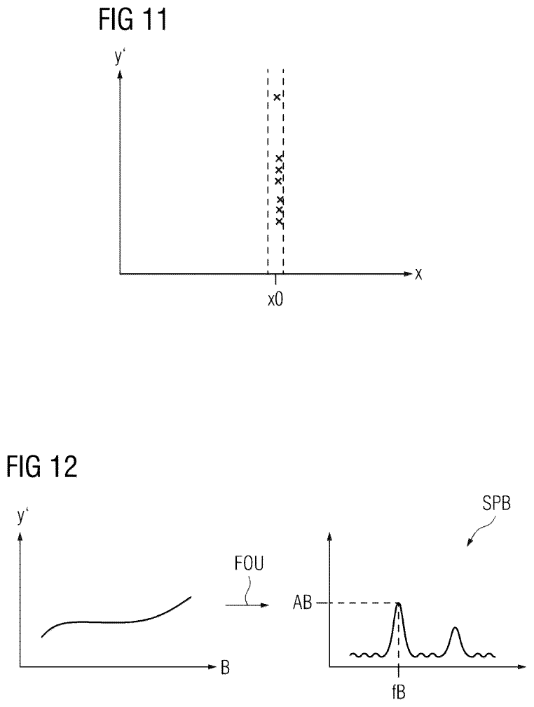

For example, as shown in FIGS. 10 and 11, in step S35 a statistical evaluation of the modified characteristics of the operator-side strip edge 4 may be effected. In particular, the evaluation means 13 may perform, for a uniform value x0 of the x-coordinate of the images B, a statistical evaluation of the y′ values occurring at this value x0. FIG. 10 shows, purely by way of example, a possible frequency distribution H of the γ′ values across the images B of the sequence for the uniform value x0, FIG. 11 shows the γ′ values occurring for the uniform value x0. For example, the mean value of the γ′ values for the uniform value x0 and the scatter or the variance around this mean value may be utilized as statistical variables. The evaluation means 13 may perform the determinations—separately from each other—for a plurality of uniform values x0. This allows location resolution of the statistical evaluation in the x direction.

The evaluation means 13 then determines the measure M1 on the basis of the determined statistical values. For example, the greater the scatter or variance, the greater the measure M1 may be. The mean values may also be used and evaluated in a manner similar to that of FIGS. 7 and 8.

As an alternative to a statistical evaluation, it is possible for the evaluation means 13 to perform, for the uniform value x0 of the x-coordinate of the images B, a time-based evaluation of the γ′ values occurring at this uniform value x0. For example, the evaluation means 13 may evaluate the change over time of the γ′ values for the uniform value x0 over the sequence of images B. FIG. 12 shows an example of a possible time-based characteristic of the γ′ values for a particular uniform value x0. For example, as also represented in FIG. 12, the evaluation means 13 may determine a time spectrum SPB of the change over time of the γ′ values, and evaluate the time spectrum SPB. The determination of the time spectrum SPB is indicated in FIG. 12 by the letters “FOU” for Fourier transformation.

For example, the evaluation means 13 may determine the greatest AB and the associated time frequency fB in the time spectrum SPB, and determine the measure M1 on the basis of these two values. The measure M1 depends at least on the greatest amplitude AB and, the greater the greatest amplitude AA, the greater is that measure. The dependence on the associated time frequency fB is usually less. Other types of evaluation are also possible.

The evaluation means 13 may perform the time-based evaluation—for example the type of evaluation represented in FIG. 12—separately for a plurality of uniform values x0. It is thus possible for the determination to be effected with location resolution in the x-coordinate. On the basis the of determination of the time-based characteristic, or time-based characteristics, with location resolution, the evaluation means 13 may then determine the measure M1 for the edge waviness of the operator-side strip edge 4.

Various procedures for determination the measure M1 have been explained above for the operator-side strip edge 4 and the associated functional characteristic for the representation K1. As already mentioned, entirely similar explanations apply in each case to the drive-side strip edge 5 and the associated functional characteristic for the representation K2 and the dimension M2 determined as a result.

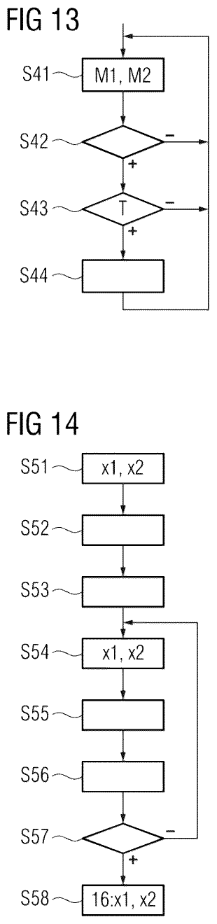

As explained above in connection with FIG. 4, the dimensions M1, M2 are determined iteratively and repeatedly. The values determined for the measures M1, M2 can therefore change over time. It is possible for the evaluation means 13 to immediately accept a newly determined value as valid. Preferably, however, the evaluation means 13 proceeds as explained below in connection with FIG. 13.

As shown in FIG. 13, the evaluation means 13 determines the dimensions M1, M2 in a step S41. Step S41 corresponds in essence to the sequence of steps S1 to S7 of FIG. 4.

In a step S42, the evaluation means checks whether there has been a change in the measures M1, M2. If this is not the case, the evaluation means 13 returns to step S41. Otherwise, the evaluation means 13 checks in a step S43 whether the change in the measures M1, M2 has already occurred for a predetermined period of time T. If this is not the case, the evaluation means 13 returns to step S41. If this is not the case, the evaluation means 13 returns to step S41. Otherwise, in a step S44 the evaluation means 13 accepts the changed measures M1, M2 as valid. Only when step S44 is executed are the modified measures M1, M2 utilized, for example output to an operator 17 (see FIG. 1). From step S44, the evaluation means 13 again returns to step S41.

The evaluation range 16 should be suitably specified. In the simplest case—for example by definition of a lower limit x1 and an upper limit x2—the evaluation range 16 of the evaluation means 13 may be defined in a fixed manner. The limits x1, x2 are shown in FIG. 6. Alternatively, it is possible for the evaluation means 13 to receive the evaluation range 16, or its limits x1, x2, from the operator 17. Alternatively again, it is possible for the evaluation means 13 to determine the evaluation range 16 automatically on the basis of the received images B. A possible procedure for this is explained below in conjunction with FIG. 14.

As shown in FIG. 14, in a step S51 the evaluation means 13 defines the lower limit x1 and/or the upper limit x2, and thus the evaluation range 16. The definition of step S51 is merely provisional.

In a step S52, the evaluation means 13 determines, in the defined evaluation range 16, for a plurality of images B—usually for all images B of the sequence subsequently evaluated—the scatter or the variance of the functional characteristic in the y-direction for the operator-side strip edge 4. In a step S53, the evaluation means 13 determines the scatter or the variance for the drive-side strip edge 5 in a similar manner.

In a step S54, the evaluation means 13 varies the lower limit x1 and/or the upper limit x2. In a subsequent step S55, the evaluation means 13 again determines the scatter or the variance for the operator-side and the drive-side strip edge 4, 5 for the now varied evaluation range 16. Step S55 corresponds to the combination of steps S52 and S53, with the exception of the fact that it is performed for the varied evaluation range 16.

In a step S56, the evaluation means 13 determines-separately for the operator-side and the drive-side strip edge 4, 5—the change in the scatter or the variance. Depending on the change, the evaluation means 13 decides, in a step S57, whether it returns to step S54 and thus varies the lower limit x1 and/or the upper limit x2 again or whether it proceeds to a step S58. In step S58, the evaluation means 13 finally adopts the most recently defined values for the lower limit x1 and/or for the upper limit x2. Step S58 concludes the determination of the evaluation range 16.

The check in step S57 may in particular include the extent to which the scatter, or the variance, has changed. If, for example, in step S51 a large evaluation range 16 is selected and is subsequently gradually reduced, the evaluation means 13 may proceed to step S58 if the change in the scatter, or the variance, has become small enough. Conversely, if in step S51 a small evaluation range 16 is selected and is subsequently gradually increased, the evaluation means 13 may proceed to step S58 if the change in the scatter, or the variance, has become too great.

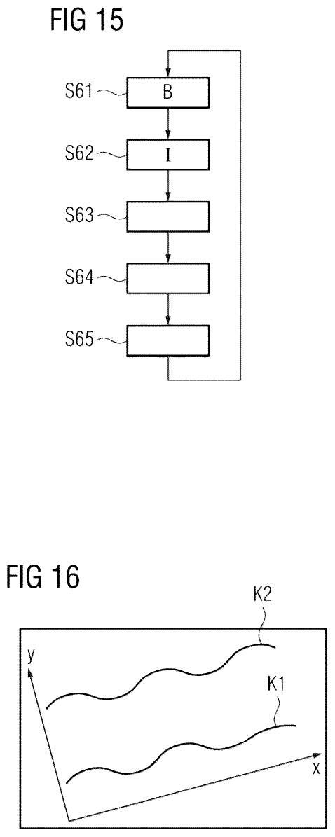

The camera 8 may vibrate during operation, and thus when capturing the images B. Such vibrations have affect the images B that are captured. Preferably, the procedure of FIG. 4 is therefore modified as follows, as shown in FIG. 15.

As shown in FIG. 15, in a step S61 the evaluation means 13 receives from the camera 8 an image B of the metal strip 2 captured by the camera 8. Step S61 corresponds to step S1 of FIG. 4.

In a step S62, information I about the movement of the camera 8 is made known to the evaluation means 13. The information Imay originate, for example, from sensors (not represented) arranged on the camera 8. In this case, the evaluation means 13 receives the information I from the sensors. Alternatively, it is possible for the information I to be extracted by the evaluation means 13 from the image B received in step S61. Combinations of these two procedures are also possible.

In a step S63, the evaluation means 13 uses the information I to determine the movement of the camera 8 in the capturing of the image B received in step S61. In a step S64, the evaluation means 13 corrects the position of the coordinate system in the image B received in step S61. FIG. 16 shows an example of a possible position of the coordinate system after the correction made by the evaluation means 13.

The evaluation means 13 then proceeds to a step S65. Step S65 corresponds to the entirety of steps $2 to S7 of FIG. 4. From step S65, the evaluation means 13 returns to step S61.

The present invention has many advantages. In particular, a simple and robust evaluation is possible. An error-prone evaluation of periodic intensity variations is not necessary. Instead, only the transition from non-strip to strip and vice versa needs to be recognized. It is not necessary for the camera 8 to be arranged over the metal strip 2. The arrangement (only) laterally above the metal strip 2 is even advantageous.

Although the invention has been illustrated and described in greater detail by the preferred embodiments, the invention is not limited by the disclosed examples, and other variations may be derived therefrom by a person skilled in the art, without departure from the scope of protection of the invention.

### LIST OF REFERENCE DESIGNATIONS

1, 7 roll stands
2 metal strip
3 bis 6 strip edges
8 camera
9, 11 connection lines
10, 12 vertical planes
13 evaluation means
14 computer program
15 machine code
16 evaluation range
17 operator
AA, AB amplitudes
b strip width
B images
fA location frequency
fB time frequency
H frequency distribution
I information
K1, K2 representations
M1, M2 measures
S1 bis steps
S65
SPA, SPB spectrum
T period of time
xB direction of transport
x0 uniform values
yB width direction
x, Y coordinates
x1, x2 limits
y′ values
yM mean value
α1, α2 angle

1. A method of determination for an edge waviness of a metal strip that extends in a width direction over a strip width from an operator-side to a drive-side strip edge and runs out of a roll stand in a direction of transport,
wherein an evaluation means iteratively and repeatedly receives from a camera an image of the metal strip captured by the camera, wherein
the camera Kamera is arranged laterally above the metal strip,
the evaluation means determines, in a two-dimensional coordinate system relating to the respective image, for the operator-side and the drive-side strip edge, the value of the one coordinate as a function of the other coordinate and thereby determines in the respective image a characteristic of the respective strip edge as a function of the other coordinate, and
the evaluation means uses the functional characteristic of the respective strip edge within a respective evaluation range of the images to determine a measure for the edge waviness of the respective strip edge.

2. The method of determination as claimed in claim 1, wherein
the direction of the other coordinate of the coordinate systems runs substantially in the direction of transport.

3. The method of determination as claimed in claim 1, wherein
the image elements of the respective image form an orthogonal, uniform grid that has two mutually orthogonal preferential directions, and the other coordinate of the coordinate systems coincides substantially with one of these two preferential directions.

4. The method of determination as claimed in claim 1, wherein
the evaluation range of the evaluation means is predefined in a fixed manner, or the evaluation means receives the evaluation range from an operator.

5. The method of determination as claimed in claim 1, wherein
the evaluation means determines the evaluation range automatically on the basis of the received images.

6. The method of determination as claimed in claim 5, wherein
the evaluation means, for the purpose of automatically determining the evaluation range,
defines a provisional lower and/or a provisional upper limit for the other coordinate and for a plurality of images determines for the respective strip edge, between the provisional lower and the provisional upper limit, the scatter or the variance of the respective functional characteristic in the direction of the one coordinate,
varies the provisional lower and/or provisional upper limit and for the plurality of images again determines, within the varied provisional lower and the varied provisional upper limit, the scatter or the variance of the respective functional characteristic in the direction of the one coordinate, and
on the basis of the change in the scatter or the variance of the respective functional characteristic in the direction of the one coordinate, determines whether and, if so, in which direction it again varies the provisional lower and/or provisional upper limit or adopts it definitively as the upper and/or lower limit.

7. The method of determination as claimed in claim 1, wherein
the evaluation means determines for the images individually the measure for the edge waviness of the respective strip edge.

8. The method of determination as claimed in claim 7, wherein
the evaluation means, for the purpose of determining the measure of the edge waviness of the respective strip edge, determines the location spectrum of the functional characteristic of the respective strip edge in the respective image and evaluates the determined location spectrum.

9. The method of determination as claimed in claim 1, wherein
the evaluation means, for the purpose of determining the measure for the edge waviness of the respective strip edge, utilizes a sequence of captured images of the metal strip.

10. The method of determination as claimed in claim 9, wherein
the evaluation means, in the images of the sequence for the purpose of evaluating the functional characteristic of the respective strip edge determines for the respective image, in the evaluation range of the respective image, the mean value of the respective functional characteristic in the direction of the one coordinate, and subtracts the determined mean value from the functional characteristic of the respective strip edge determined in the respective image, and thus determines a modified functional characteristic of the respective strip edge in the respective image and, based on the modified characteristics, performs further evaluations for the sequence of images.

11. The method of determination as claimed in claim 10, wherein
the further evaluations include a statistical evaluation of the modified characteristics of the respective strip edge in the images of the sequence.

12. The method of determination as claimed in claim 11, wherein
the statistical evaluation includes a determination, with location resolution in the other coordinate, of statistical variables of the respective modified functional characteristic in the direction of the one coordinate.

13. The method of determination as claimed in claim 10, wherein
the evaluation means determines the measure for the edge waviness of the respective strip edge by evaluating, with location resolution in the other coordinate, over the sequence of images for the modified functional characteristics of the trip edges, the change over time in the direction of the one coordinate.

14. The method of determination as claimed in claim 13, wherein
the evaluation means determines a time spectrum of the change over time in the direction of the one coordinate and evaluates the time spectrum.

15. The method of determination as claimed in claim 1, wherein
the evaluation means accepts changes in the measure for the edge waviness of the respective strip edge as valid only if these changes persist for a period of time that is greater than a minimum period of time.

16. The method of determination as claimed in claim 1, wherein
the evaluation means determines a movement of the camera during the capturing of the images and corrects the position of the respective coordinate system in the captured images by the movement of the camera before determining the functional characteristic of the respective strip edge.

17. A computer program for a software-programmable evaluation means, wherein the computer program comprises machine code that can be directly processed by the evaluation means, wherein the processing of the machine code by the evaluation means causes the evaluation means to execute a method of determination as claimed in claim 1.

18. An evaluation means, wherein die evaluation means is software-programmable and is programmed by use of such a computer program such that the evaluation means executes a method of determination as claimed in claim 1.

19. A rolling means,
wherein the rolling means has a roll stand for rolling a metal strip extending in a width direction over a strip width from an operator-side to a drive-side strip edge, such that the metal strip runs out of the roll stand in a direction of transport,
wherein the rolling means has a camera, which is arranged laterally above a pass line on which the metal strip runs out of the roll stand,
wherein the rolling means has an evaluation means that is connected to the camera via a data link for the purpose of receiving images captured by means of the camera, is realized as an evaluation means that executes a method of determination as claimed in claim 1.

20. The rolling means as claimed in claim 19, wherein
it has a further roll stand, which is arranged on the outlet side of the first-mentioned roll stand, and the camera is arranged between the first-mentioned roll stand and the further roll stand, as viewed in the direction of transport of the metal strip.

21. The rolling means as claimed in claim 19 wherein
the camera is arranged in such a manner that that an operator-side connection line from the camera to the operator-side strip edge forms, together with an operator-side vertical plane that includes the operator-side strip edge, an operator-side angle that is between 30° and 70°, and/or a drive-side connection line from the camera to the drive-side strip edge forms, together with a drive-side vertical plane that includes the drive-side strip edge, a drive-side angle that is between 30° and 70°.
